(19) United States
(12) Patent Application Publication
(10) Pub. No.: US 2011/0274763 A1
(43) Pub. Date: Nov. 10, 2011

(54) Slow releasing microcapsules and microspheres containing an active substance

(76) Inventors: Bo Magnus Nydén, Billdal (SE); Lars Olof Nordsstierna, Gothenburg (SE); Elzbieta Maria Bernad, Goteborg (SE); Alla Mahmoud Atta Ahmed Abdalla, Goteborg (SE)

(21) Appl. No.: 12/800,292

(22) Filed: May 12, 2010

Related U.S. Application Data
(60) Provisional application No. 61/216,589, filed on May 19, 2009.

(51) Int. Cl. A01N 47/12; A01N 31/08; A01N 25/12; A01N 47/28; A01N 55/02; A01N 43/80; A01N 43/66; A01N 43/50; A01P 1/00

(52) U.S. Cl. 424/497; 514/478; 514/396; 514/731; 514/188; 514/372; 514/241; 514/588

(57) ABSTRACT

A production method is provided for the preparation of small polymer microcapsules with an oil core and solid microspheres, containing high amounts of biocide by internal phase separation from emulsion droplets with ethyl acetate as a solvent. The size of the microcapsules and microspheres can be controlled with a high degree of accuracy between 0.2-20 micrometers in diameter. The microparticles are particularly well suited for coatings such as paints, lacquers and wood preservatives which are to be protected against microorganisms using biocides, as well as for surface protection directly, i.e. without combining the microparticles with a coating material.

### CROSS-REFERENCE TO RELATED APPLICATIONS

This application claims priority from U.S. Provisional Patent Application Ser. No. 61/216,589 filed May 19, 2009.

### BACKGROUND OF THE INVENTION

1. Field of the Invention

The present invention relates generally to polymer microcapsules and microspheres containing biocides and the preparation thereof. More particularly, the present invention relates to microcapsules and microspheres having a controlled size, containing high amounts of various biocides. The size can be controlled with a high degree of accuracy between 0.2-20 micrometers in diameter. The invention also relates to a process for preparation of microcapsules and microspheres by internal phase separation from emulsion droplets and the use of ethyl acetate in the emulsion in order to suppress any formation of macroscopic plastic granulates. The invention is particularly well suited for coatings such as paints, lacquers and wood preservatives, which are to be protected against microorganisms using biocides. Protection of plant seedlings against noxious insects is another application. The invention is also well suited for surface protection directly, i.e. without combining the microcapsules or microspheres with a coating, material.

2. Description of the Related Art

Biocides are chemical compounds that prevent the growth of microorganisms. Today biocides are used in a range of products, such as coatings, wood preservatives and crops, to prevent the growth of microorganisms. The use of biocides is often associated with a number of problems. Common problems are that the biocide diffuses out and is washed off from the product or application site too fast which causes the protection to disappear, that there is chemical degradation of the biocide due to reactions with the surroundings or that there is chemical degradation of the product due to reactions with the biocide. An option to prolong the release of biocides simultaneously as the biocide and the product are protected is through microencapsulation.

The term “biocide” as used herein is to be understood to refer to agents such as germicides, bactericides, fungicides, algicides and the like, which are used for their ability to inhibit growth of and/or destroy biological and/or microbiological species such as bacteria, fungi, algae, fouling organisms and the like.

Microcapsules are small spheres with a uniform wall around them. The material inside a microcapsule is referred to as the core, whereas the wall is sometimes called the shell. Microcapsules herein have a spherical polymer shell and a core of oil, where the biocide is located. Microspheres are spherical polymer matrices where the biocide is homogeneously distributed. However, the terms microcapsules and microspheres are often used synonymously. A general name in this document, that comprises both microcapsules and microspheres, is microparticles.

Phase separation, solvent evaporation, emulsification, and spray drying are examples of different techniques currently used for producing microparticles. The present invention focuses on production of microparticles by internal phase separation from emulsion droplets. According to this technique, emulsion droplets of an organic solvent, where the biocide and polymer are dissolved, are dispersed in an aqueous medium containing surface-active molecules and co-solvents. During evaporation of the organic solvent, stable microparticles are formed. This technique has already been reported in the literature using the environmentally harmful solvent DCM (Dichloromethane) (1), a compound that in turn requires the use of environmentally harmful co-solvents.

As previously explained microcapsules are ideal delivery systems for prolonging the release rate of biocides. A slow release is of high importance when it comes to protection of products with a long lifespan, such as paints, coatings, wood preservatives, and plant protection. For example, it is desirable that the biocide is released during the entire life of the coating material, i.e. for 10-15 years. As a rule, the overall characteristics of the microparticles will influence the release-kinetics of the active ingredient. Thus, the release rate of biocide out of the microparticles can be controlled by modifying the microcapsule shell wall chemistry, shell wall thickness and morphology, the solvent(s) in the core and the particle size, among others factors. Accordingly, controlled release using microcapsules and the production thereof has long been the subject of widespread research.

U.S. Patent Application Publication No. 2007/0053950 describes the composition of microcapsules containing biocides, especially Irgarol (algicide) and Zinc Pyrithione (fungicide) to increase the life of coating material from the attack of algae and fungi. The claimed encapsulating polymers are: polymethylmethacrylate (PMMA), polystyrene, polyvinylpyridine-co-styrene, polyamide, polyester, ethyl cellulose and polyurethane. Further, this document describes a coating material that is 2-20% of the microcapsule, with a particle size of about 5-15 micrometers.

International publication WO 2007/039055 A2, teaches formulations in water suspension of microcapsules based on 3-iodo-2-propynyl butylcarbamate (IPBC). The microcapsules have sizes of 1-30 microns, preferably from 2 to 20 microns and comprise a reservoir of biocidal active in admixture with a suitable co-formulating agent (synergizing agent), and an external wall. The wall is formed by a polymeric membrane insoluble in water and obtained by in situ interfacial polymerization. The biocide is released after only 8 hours in water suspension.

U.S. Pat. No. 7,429,392 relates to a coating material for protection against microorganism invasion on surfaces that are exposed to the effects of dampness or water. The coating material is characterized in that it contains a biocide which bonds to solid particles in a carrier material and is released in a delayed manner therefrom. The particularly preferred wall materials are formaldehyde-melamine resins. Several others are mentioned, and among them PMMA. The claimed encapsulated biocides are: IPBC, 1H-benzimidazol-2-ylcarbamate (carbendazim), 2-pyridinethiol 1-oxidezinc (zinc pyri-thione), OIT, and DCOIT; the claimed algicides include triazines and N,N-diamethylureas; and the particularly preferred microcapsule wall materials are formaldehyde-melamine resins

U.S. Patent Application Publication No. 2006/0246144 discloses polymer microcapsules containing different biocides such as Irgarol and Zinc Pyrithione and having a particle size distribution in the range of 1-100 microns but preferably 2-50 microns. The microcapsules are prepared using the solvent evaporation technique by dispersing an organic phase containing an active agent either in a dissolved state or a dispersed state in a polymer solution using a low boiling point solvent, in an aqueous phase containing an emulsifying agent; agitating the emulsion at 800-1200 revolutions per minute for 3-5 hours at 25-27° C. to evaporate the low boiling point solvent and thus to permit the formation of the microcapsules; separating the microcapsules; washing with water and drying the microcapsules at temperature between 25-35° C. The encapsulating polymer is selected from a group consisting of PMMA, polystyrene, copolymer such as poly(vinylpyridine-co-styrene) and organic polymer such as ethyl cellulose. There is no information about the rate of biocide release. The reference mentions the use of ethyl acetate as additional solvent in the method of producing microcapsules but since EA is miscible with water the microcapsules obtained by this method will have macroscopic plastic granulates.

Two different references by Loxley et al. and Dowding et al. (1, 2) describe the formulation of core-shell microcapsules with polymer shell and liquid oil interior, enabling the encapsulation of a small amount (0.5-1%) of organic compound. Dichloromethane is the preferred solvent used and a UV-active organic molecule is added to the oil phase prior to emulsification. Further, there is teaching of a controlled release process where almost all of the encapsulated agent is released after only some hours or days in water suspension.

Despite the large number of patents and other documents within the area, there is still a need for methods yielding very small microparticles being able to encapsulate large amount of biocides that are release at extremely slow rates.

Another good reason for using small microparticles, apart from a controlled release of biocide, is related to the properties of lacquers. When using microparticles of small size, the light scattering could be minimized with regard to visual appearance, an important property in a clear lacquer.

In the case of direct surface protection, i.e. without combining the microparticles with a coating material such as a water-based or solvent-based paint, a water dispersion of the pure microparticles system may be sprayed directly onto wood, for example. Microparticles of small size can penetrate into the wood material much easier than larger microparticles,

Wood impregnation methods commonly used today rely on the use of high temperatures and/or high pressures to get enough active substance deep enough into the wood. By using small-sized microparticles the process of protecting the wood from fungi growth is much cheaper and faster while still allowing for the long lasting protection.

In general, the microencapsulation technique can be useful in a broad portfolio of applications. For example, microcapsules can be used for delivery of biocides in marine coating formulations or paints. One of the problems in marine paints today with regard to using small organic biocides is that they are depleted from the coating much too rapidly leading to an early loss in antifouling efficiency. By microencapsulation, the biocides are prevented from diffusing through the coating and thereby the antifouling efficiency of the coating is made to last over a much longer time period.

On the other hand, an efficient protection of growing plant seedlings against insects is the application of a polymer-coating matrix where antifeedants, i.e. BHT, are incorporated. Gradual release of the latter holds back the insect attack. By the use of microcapsules and microspheres, the release of antifeedants can be controlled and prolonged.

The invention herein overcomes the drawbacks of the present methods and serves a wide range of applications by providing novel and specially developed polymer microcapsules and microspheres. The small and controlled size of said microparticles together with the production method and the use of selected compounds and formulations enable an extremely slow release of biocide and give a low production cost. These desired effects are reached without affecting the physical and mechanical properties of the paints.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### SUMMARY OF THE INVENTION

A primary object of the present invention is to provide a production method resulting in small microcapsules and microspheres containing large amount of active substances with an extremely slow release. Another object of the present invention is to prolong the protection of long-life products, such as paints, coatings and wood preservatives, through the extremely slow release of biocides. Another object of the present invention is to use ethyl acetate as an organic solvent in the emulsification preparation step of the internal phase separation from emulsion droplets technique, without unwanted plastic granulate formations. The microparticles are produced with either the active substance dispersed in a solid microsphere or with the active substance dispersed in a microcapsule with an oil core. Objects and features of the inventions will be more fully apparent from the following disclosure.

### BRIEF DESCRIPTION OF THE DRAWINGS

FIG. 1 is a graph showing slow release of IPBC from microcapsules (octadecane core).

FIG. 2 is a graph showing the extremely slow release of IPBC from microspheres. In water suspension the release can be as low as 0.5% per month, in other words, there is a biocide content for more than 15 years, which is enough to last for a coating's entire life.

FIG. 3 is a graph showing the release of medetomidine from paint surfaces of plates immersed in water. Each point represents the mean of triplicate measurements corresponding to each experimental group. The squared points refer to the release results of a water-based paint with the biocide free in the coating; the circular ones refer to samples from water-based paints with the biocide encapsulated; the triangular points show the results of an oil-based paint with free biocide and the inverted triangular points are the same samples but containing the microencapsulated medetomidine. The effect of microparticles is strong with regard to decreased release rate. Note the log-log scales of the axes.

FIG. 4 is a graph showing the results of IPBC release from painted surfaces. Each point represents the mean of triplicate measurements corresponding to each experimental group. The squared points refer to the biocide-free (no encapsulated) paint sample; the triangular to the samples with encapsulated biocide at 25% loading and the circular points refer to samples with encapsulated biocide with 10% loading.

### DETAILED DESCRIPTION OF THE INVENTION AND PREFERRED EMBODIMENTS THEREOF

The present invention includes microcapsules and microspheres containing an active substance and the preparation thereof. The present invention is suitable for prolonging the protection of long-life products, such as paints, coatings and wood preservatives, through extremely slow release of biocides. The slow release prolongs the life of the biocide and the protection time. The invention provides microcapsules and microspheres comprising but not limited to 3-iodo-2-propynyl butylcarbamate (IPBC) or butylated hydroxytoluene (BHT) or octyl-isothiazolinone (OIT) or 4,5-dichloro-2-n-octyl-3-isothiazolinone (DCOIT) or tolylfluanide (TF) or 4-[1-(2,3-dimethylphenyl)ethyl]-3H-imidazole (medetomidine) or a combination thereof as the active substance, with a wall material comprising but not limited to poly(methylmethacrylate) (PMMA), polystyrene, polyvinylpyridine-co-styrene, polyamide, polyester, ethyl cellulose and polyurethane.

The production method hereby employed is the internal phase separation from emulsion droplets, which in combination with the active substance and the wall material, enables a high precision of size and wall thickness, which is important to control the release of the active substance. Having small-sized microparticles is also important in preventing an alteration of the physical/mechanical properties of the coating material. The present invention provides an alternative production method where the organic solvent is eliminated from the internal phase separation from emulsion droplets. This alternative production method enables the production of microparticles, at a very low cost as the necessary solvents used in the current methods are replaced by the cheaper and more environmentally friendly solvent ethyl acetate.

The use of ethyl acetate (EA) as a solvent instead of DCM with the internal phase technique is known in the art to result in undesirable macroscopic plastic granulates. Thus, the inventors have been unable to find any teaching in the prior art of a method for producing microparticles using ethyl acetate with the internal phase separation technique.

Unexpectedly, the inventors herein found that the use of a large amount of ethyl acetate in the emulsion was crucial in order to suppress any formation of macroscopic plastic granulates. The use of high concentrations of EA in the emulsion surprisingly also showed that the use of co-solvents, i.e. acetone, is not needed. Thus, the invention provides for the production of very small microparticles combining the use of EA and an internal phase separation technique with a high shear rate of the emulsification homogenizer. This in turn enables a high precision of particle size and shell thickness, which is important for controlling the release of biocide.

Thus the microcapsules and microspheres produced by the production method of the invention herein can be distinguished from previously known microcapsules or similar techniques by their extremely slow release of substance through the microcapsules and microspheres, their solid construction which makes them extremely durable, and their small size ranging between 0.2-20 microns and preferably between 0.2-10 microns. This invention also enables the microparticles (depending on the type of biocide) to be loaded with a biocide having concentrations up to, for specific biocides, at least 25% compared to the total weight of the microcapsule.

The slow release is accomplished through the formation of the permeability of the microcapsule core and the polymer shell. The desired release rate is reached by controlling the size of the microparticles, the wall thickness and the core material. The microparticles are produced with either the active substance dispersed in a solid microsphere or with the active substance dispersed in a microcapsule with an oil core. Depending of the release rate to be obtained, a specific particle is to be preferred. Microspheres give slower release compared to microcapsules of the same size.

To reach an optimal protection on coatings such as paints or lacquers, or for wood preservatives, the microcapsules and microspheres need to be mixed with a blend of biocides that have effects on different microorganisms.

The present invention may comprise, but is not limited to, poly(methylmethacrylate) (PMMA) as a wall material. Other possible wall materials are: polyamides, polyesters, polyvinylalcohols, polyurethanes, polyurea, polylactic acid, polystyrene and polyvinylpyridine-co-styrene.

The present invention may comprise, but is not limited to, 3-iodo-2-propynyl butylcarbamate as the active substance. Other possible active substances are biocides such as: 1H-benzimidazol-2-ylcarbamate (carbendazim), 2-pyridinethiol 1-oxidezinc (zinc pyrithione), irgarol, OIT, DCOIT, tolulfluanide, medetomidine, triazines, N,N-diamethylureas; pheromones such as BHT; insecticides; cosmetics; and perfumes.

In the case with oil core microcapsules, the present invention may comprise, but is not limited to, corn oil or octadecane as the oils. Other possible oils are dodecane, hexadecane, rape oil, sunflower oil, soybean oil, and palm oil.

The microparticles of the present invention are compatible with water-based and solvent-based paints and are suitable for areas where controlled slow release is desired. Such areas include, but are not limited to, the release of biocides in paints, coatings and wood preservatives and the release of pheromones to protect crops and forests from insects. Other areas of use include, but are not limited to, pharmaceuticals and cosmetics.

The coating material is preferably a paint or lacquer.

Production:

The microparticles are produced through internal phase separation from emulsion droplets. The aqueous phase and organic phase are prepared separately. The aqueous phase comprises water, an emulsifier, and sometimes a fraction of organic solvent. The organic phase comprises the organic solvent, oil (for microcapsules with an oil core), the polymer that will form the walls, the active substance, and sometimes a co-solvent. In the case of solid microcapsules without an oil core, no oil is used in the production. An oil-containing microcapsule for example will give faster release than a dense microparticle.

The production method preferably comprises three fundamental steps:
1. The organic phase is slowly added, in equal amount, to a portion of the aqueous phase, under rigorous stirring with a homogenizer, at 200-20000 rpm. This first step results in an emulsion with the droplet size of 0.2-20 micrometers and preferably 0.2-10 micrometers. In total the emulsion is stirred for one hour. Higher shear rate generates smaller particles and more narrow particle size distribution. Higher polymer content gives higher viscosity under thereby larger particles and broader particle size distribution.
2. The emulsion is mixed with an additional portion of the aqueous phase. The emulsion is then evaporated to get rid of the organic solvent and possible co-solvents. When the solvents evaporate the polymer phase separates which results in a dense shell forming around the oil, or, in a spherical matrix. Technically speaking, at this stage the emulsion has turned into a suspension.
3. Finally the suspension is centrifuged or sedimented from the aqueous phase to collect the formed microparticles.

As shown in the examples below, the use of ethyl acetate in the aqueous phase is required in those cases when a reduction of ethyl acetate in the organic phase is desired. This is due to the fact that the amount of EA that needs to be added to the aqueous phase is considerably inferior to the amount one should remove from the organic phase for obtaining the desire reduction in the organic phase.

Polyvinyl alcohol (PVA) is the emulsifier or surfactant that keeps the emulsion droplets stable so that the EA-phase does not separate from the water. The physical characteristics and its specific functional uses depend on the degree of polymerization and the degree of hydrolysis. The degree of hydrolysis affects the surface tension and stability between emulsion droplet and water surrounding.

The inventors herein have surprisingly found that if too little ethyl acetate is used while employing PVA of 95% degree of hydrolysis, then plastic formation may occur. A reduction in the hydrolysis degree of PVA to e.g. 88% helps preventing any plastic formation in the emulsion. This reduction in the PVA hydrolysis degree further allows for a reduction in the amount of EA in the organic phase and its presence in the aqueous phase is no longer necessary. The shear rate and the concentration of the afore-mentioned substances, among other factors can be modified to control the size and morphology of the microparticles containing the biocide.

In the examples below acetone is used, as is known in the art, for reducing the poly-dispersity of microcapsule size and thus stimulating the formation of the emulsion. However, it has to be noted that in some applications such as in paint applications, its presence in the formulation could be obviated.

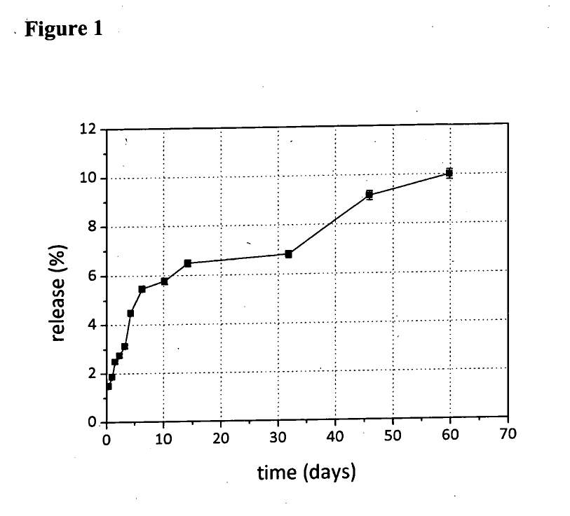

Laboratory studies reveal an extremely slow release of biocide from microparticles. In water suspension the release can be as low as 0.5% per month, which is translated to a biocide content that lasts for more than 15 years, nearly a coating's entire life (FIG. 1). Accordingly, a water dispersion of the microparticles of this invention might be used with direct surface protection of e.g. wood for offering long lasting protection.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the features of the invention, to include variations in size, materials, shape, form, function and manner of operation; production and use, are deemed readily apparent and obvious to one skilled in the art.

Therefore, the foregoing is considered as illustrative only of the principles of the invention. Further, since numerous modifications and changes will readily occur to those skilled in the art, it is not desired to limit the invention to the exact composition and usage shown and described, and accordingly, all suitable modifications and equivalents may be resorted to, falling within the scope of the invention.

The present invention is further illustrated by the following examples of production.

### Example 1

### Preparation of Microcapsules Comprising a PMMA Shell, 16% IPBC, and Dodecane Core, without EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 4 g of poly(methylmethacrylate) (PMMA) (Aldrich, MW 350,0000) with 90 ml ethyl acetate (EA) (Acros Organics, ≧99.6%) under stirring. When the PMMA is dissolved, 3.8 ml of acetone (Merck, ≧99.5%), 5 ml dodecane (Fluka, 98%) and 1.50 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 9.4 g of formed microcapsules. The sizes of the microcapsules are between 0.2 and 20 micrometers, with the size of the majority of microcapsules being between 1-6 but most often between 2 and 4 micrometers in diameter. The microcapsules comprise a PMMA shell, IPBC, and dodecane core.

### Example 2

### Preparation of Microcapsules Comprising a PMMA Shell, 16% IPBC, and Hexadecane Core without EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 4 g of poly(methylmethacrylate) (PMMA) (Aldrich, MW 350,0000) with 90 ml ethyl acetate (EA) (Acros Organics, ≧99.6%) under stirring. When the PMMA is dissolved, 3.8 ml of acetone (Merck, ≧99.5%), 5 ml of hexadecane and 1.51 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 9.4 g of formed microcapsules. The sizes of the microcapsules are between 0.2 and 20 micrometers, with the size of the majority of microcapsules being between 1-7 and in most cases between 3 and 5 micrometers in diameter. The microcapsules comprise a PMMA shell, IPBC, and hexadecane core.

### Example 3

### Preparation of Microspheres Comprising a PMMA and 16% IPBC, with EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 8 g of poly(methylmethacrylate) (PMMA) (Aldrich, MW 350,0000) with 57 ml ethyl acetate (EA) (Acros Organics, ≧99.6%) under stirring. When the PMMA is dissolved, 3.8 ml of acetone (Merck, ≧99.5%) and 1.51 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase, where 9 ml ethyl acetate is added, for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 9.5 g of formed microspheres. The sizes of the microspheres are between 0.2 and 20, with the size of the majority of microspheres being between 1-7 but most often between 3 and 5 micrometers in diameter. The microspheres comprise a PMMA solid sphere inside which IPBC is located.

### Example 4

### Preparation of Microspheres Comprising a PMMA and 16% IPBC, without EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 8 g of poly(methylmethacrylate) (PMMA) (Aldrich, MW 350,0000) with 90 ml ethyl acetate (EA) (Acros Organics, ≧99.6%) under stirring. When the PMMA is dissolved, 3.8 ml of acetone (Merck, ≧99.5%) and 1.5 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 9.5 g of formed microspheres. The sizes of the microspheres are between 0.2 and 10 micrometers, with the size of the majority of microspheres being between 2 and 6 but most frequently between 4 and 5 micrometers in diameter. The microspheres comprise a PMMA solid sphere inside which IPBC is located.

### Example 5

### Preparation of Microspheres Comprising a PMMA and 16% IPBC, without EA in the Aqueous Phase

The aqueous phase is prepared by mixing 4 g of poly(vinylalcohol) (88% degree of hydrolysis) in 200 ml of water under stirring and heating to 60-95° C. The oil phase is prepared by mixing 8 g of poly(methylmethacrylate) (PMMA) (Aldrich, MW 350,0000) with 57 ml ethyl acetate (EA) (Acros Organics, ≧99.6%) under stirring. When the PMMA is dissolved, 3.8 ml of acetone (Merck, ≧99.5%) and 1.5 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 9.5 g of formed microspheres. The sizes of the microspheres are between 0.2 and 10 micrometers, with the size of the majority of microspheres being between 2-6 but most often between 4 and 5 micrometers in diameter. The microspheres comprise a PMMA solid sphere inside which IPBC is located.

### Example 6

### Preparation of Microspheres Comprising a PMMA and 25% IPBC, with EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 8 g of poly(methylmethacrylate) (PMMA) (Aldrich, MW 350,0000) with 57 ml ethyl acetate (EA) (Acros Organics, ≧99.6%) under stirring. When the PMMA is dissolved, 3.8 ml of acetone (Merck, ≧99.5%) and 2.67 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase, where 9 ml ethyl acetate is added, for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 10.7 g of formed microspheres. The sizes of the microspheres are between 0.2 and 20 micrometers, with the size of the majority of microspheres being between 3-9 and predominantly between 4 and 7 micrometers in diameter. The microspheres comprise a PMMA solid sphere inside which IPBC is located.

### Example 7

### Preparation of Microspheres Comprising a PMMA and 25% IPBC, Showing that the Production Method is Stable for Larger Batches

The aqueous phase is prepared by mixing 20 g of poly(vinylalcohol) (95% degree of hydrolysis) in 1000 ml of water under stirring and heating to 60-95° C. The oil phase is prepared by mixing 40 g of poly(methylmethacrylate) (PMMA) (Aldrich, MW 350,0000) with 285 ml ethyl acetate (EA) (Acros Organics, ≧99.6%) under stirring. When the PMMA is dissolved, 19 ml of acetone and 13.35 g of 3-iodo-2-propynyl butylcarbamate (IPBC) (Aldrich, 97%) are added. EA dissolves the PMMA and acetone stimulates the forming of the emulsion.

The oil phase is slowly added to 400 ml of the aqueous phase, where 45 ml ethyl acetate is added, for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase under 250 rpm stirring. The emulsion is evaporated and finally centrifuged to extract 53.4 g of formed microspheres. The sizes of the microspheres are between 0.2 and 20 micrometers, with the size of the majority of microspheres being between 3-10 and most frequent between 4 and 6 micrometers in diameter. The microspheres comprise a PMMA solid sphere inside which IPBC is located.

### Example 8

### Preparation of Microspheres Comprising a PMMA and 25% IPBC, with Acetone and without EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 8 g of poly(methylmethacrylate) (PMMA) (Aldrich, MW 350,0000) with 90 ml ethyl acetate (EA) (Acros Organics, ≧99.6%) under stirring. When the PMMA is dissolved, 3.8 ml of acetone (Merck, ≧99.5%) and 2.67 g of 3-iodo-2-propynyl butylcarbamate (IPBC) (Aldrich, 97%) are added. EA dissolves the PMMA and acetone stimulates the forming of the emulsion.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 10.7 g of formed microspheres. The sizes of the microspheres are between 0.2 and 20 micrometers, with the size of the majority of microspheres being between 2-7 and predominantly between 3 and 6 micrometers in diameter. The microspheres comprise a PMMA solid sphere inside which IPBC is located.

### Example 9

### Preparation of Microspheres Comprising a PMMA and 25% IPBC, without Acetone and without EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 8 g of poly(methylmethacrylate) (PMMA) (Aldrich, MW 350,0000) with 100 ml ethyl acetate (EA) (Acros Organics, ≧99.6%) under stirring. When the PMMA is dissolved 2.7 g of 3-iodo-2-propynyl butylcarbamate (IPBC) (Aldrich, 97%) are added. EA dissolves the PMMA.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 10.7 g of formed microspheres. The sizes of the microspheres are between 0.2 and 20 micrometers, with the size of the majority of microspheres being between 2-8 but primarily between 4 and 6 micrometers in diameter. The microspheres comprise a PMMA solid sphere inside which IPBC is located.

### Example 10

### Preparation of Microspheres Comprising a PMMA and 25% IPBC, without Acetone and without EA in the Aqueous Phase

The aqueous phase is prepared by mixing 4 g of poly(vinylalcohol) (88% degree of hydrolysis) in 200 ml of water under stirring and heating to 60-95° C. The oil phase is prepared by mixing 8 g of poly(methylmethacrylate) (PMMA) (Aldrich, MW 350,0000) with 57 ml ethyl acetate (EA) (Acros Organics, ≧99.6%) under stirring. When the PMMA is dissolved 2.7 g of 3-iodo-2-propynyl butylcarbamate (IPBC) (Aldrich, 97%) are added. EA dissolves the PMMA.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 10.7 g of formed microspheres. The sizes of the microspheres are between 0.2 and 20 micrometers, with the size of the majority of microspheres being between 2-8 and predominantly 4 and 6 micrometers in diameter. The microspheres comprise a PMMA solid sphere inside which IPBC is located.

### Example 11

### Preparation of Microspheres Comprising a PMMA and 10% Medetomidine with EA in the Aqueous Phase

The aqueous phase is prepared by mixing 4 g of poly(vinylalcohol) (95% degree of hydrolysis) in 200 ml of water under stirring and heating to 60-95° C. The oil phase is prepared by mixing 8 g of poly(methylmethacrylate) (PMMA) (Aldrich, MW 350,0000) with 57 ml ethyl acetate (EA) (Acros Organics, ≧99.6%) under stirring. When the PMMA is dissolved, 3.8 ml of acetone (Merck, ≧99.5%) and 0.89 g of 3medetomidine are added. EA dissolves the PMMA and acetone stimulates the forming of the emulsion.

The oil phase is slowly added to 80 ml of the aqueous phase, where 9 ml ethyl acetate is added, for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 8.9 g of formed microspheres. The sizes of the microspheres range between 0.2 and 20 micrometers, with the size of the majority of microspheres being between 2-8 but most frequently between 4 and 7 micrometers in diameter. The microspheres comprise a PMMA solid sphere inside which medetomidine is located.

### Example 12

### Preparation of Microcapsules Comprising a PMMA Shell, 16% BHT, and Hexadecane Core without EA in the Aqueous Phase

The aqueous phase is prepared by mixing 4 g of poly(vinylalcohol) (88% degree of hydrolysis) in 200 ml of water under stirring and heating to 60-95° C. The oil phase is prepared by mixing 4 g of poly(methylmethacrylate) (PMMA) (Aldrich, MW 350,0000) with 57 ml ethyl acetate (EA) (Acros Organics, ≧99.6%) under stirring. When the PMMA is dissolved, 3.8 ml of acetone (Merck, ≧99.5%), 5 ml of hexadecane and 1.51 g of butylated hydroxytoluene (BHT) are added. EA dissolves the PMMA and acetone stimulates the forming of the emulsion.

The oil phase is slowly added to 80 ml of the aqueous phase for 15 min at 5000 rpm stirring with a homogenizer of the type Silent Crusher M tool 22F (produced by Heidolph Instruments). Then the mixture is stirred at this shear rate for 45 min. The formed emulsion is added to the remaining aqueous phase at 250 rpm stirring. The emulsion is evaporated and finally centrifuged to extract 9.4 g of formed microcapsules. The sizes of the microcapsules are between 0.2 and 20 micrometers, with the size of the majority of microcapsules being between 1 and 7 and most often between 3 and 5 micrometers in diameter. The microcapsules comprise a PMMA shell, IPBC, and hexadecane core.

### Example 13

### Preparation of Microspheres Comprising a PMMA and 25% IPBC, Showing that Inline Homogenization Works

The aqueous phase is prepared by mixing 24 g of poly(vinylalcohol) (95% degree of hydrolysis) in 1200 ml of water under stirring and heating to 60-95° C. 100 ml ethyl acetate (Acros Organics, ≧99.6%) is then added to the aqueous phase. The oil phase is prepared by mixing 48 g of poly(methylmethacrylate) (PMMA) (Aldrich, MW 350,0000) with 540 ml ethyl acetate (EA) under stirring. When the PMMA is dissolved, 22.8 ml of acetone and 16.2 g of 3-iodo-2-propynyl butylcarbamate (IPBC) (Aldrich, 97%) are added. EA dissolves the PMMA and acetone stimulates the forming of the emulsion.

The aqueous phase is recirculated through a homogenizer (Kinematica Megatron MT3000 equipped with a Type MTG 30/4 generator) at 15000 rpm (˜7 l/min). The organic phase is then slowly injected into the rotor during 9 minutes. The formed emulsion is recirculated during 2 minutes. The emulsion is evaporated and finally centrifuged to extract 64 g of formed microspheres. The sizes of the microspheres are between 0.2 and 20 micrometers, with the size of the majority of microspheres being between 3 and 10 and predominantly between 3-8 micrometers in diameter. The microspheres comprise a PMMA solid sphere inside which IPBC is located.

### Example 14

### Study of IPBC Release from Microcapsules

Microcapsules (octadecane core) in an aqueous suspension (20 ml) were immersed into a dialysis membrane (M_{W} 12-14.000) and placed into a flask containing 100 ml deionized water. This flask was placed on mechanical shaker at moderate speed (90 min⁻¹). The outer water phase was investigated and entirely replaced with fresh water at different time intervals. After separation into dichloromethane, GC-measurements of each sample provided IPBC concentration, which was converted into weight percent released and plotted against time to obtain release curves. FIG. 1 shows the data of triplicate measurements for each time interval. After one month, 7% of the IPBC is released.

### Example 15

### Study of IPBC Release from Microspheres

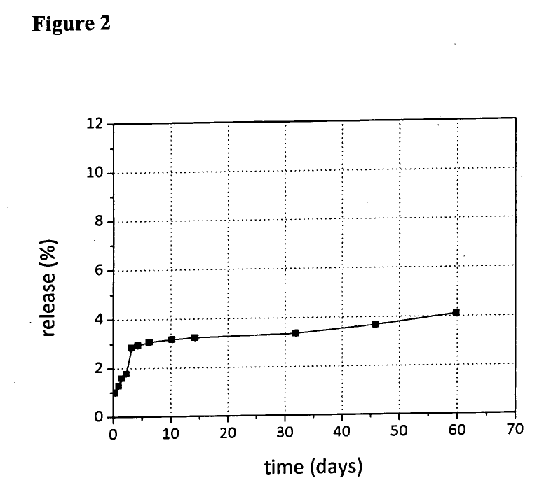

A microsphere aqueous suspension (20 ml) was immersed into a dialysis membrane (M_{W} 12-14.000) and placed into a flask containing 100 ml deionised water. This flask was placed on mechanical shaker at moderate speed (90 min⁻¹). The outer water phase was investigated and entirely replaced with fresh water on different time intervals. After separation into dichloromethane, GC-measurements of each sample provided IPBC concentration, which was converted into weight percent released and plotted against time to obtain release curves. Mean from triplicate measurements are shown on FIG. 2. After one month, 3.5% of the IPBC is released.

### Example 16

### Study of Medetomidine Release from Painted Surfaces

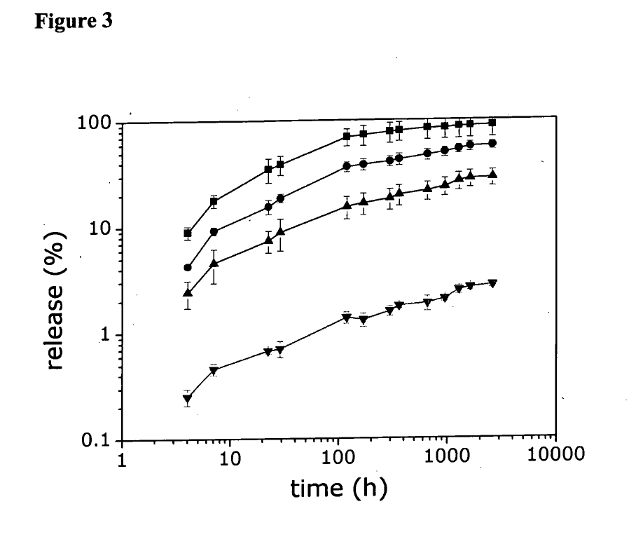

Four different 30 g paint samples were prepared. Two of the samples were based on biocide-free and water-based standard white exterior wall paint, while the two other samples were based on biocide-free and organic solvent-based standard white exterior wall paint. Medetomidine was added to each sample, either in free form or the form of microspheres. ¹⁴C-labelled material was 2.3% of all medetomidine. Wet paint contained in total 0.4% medetomidine. Stirring the paint with an electrical mixer assured homogeneous dispersion of the added substance. For the release studies, approximately 1 g (dry state) of the paint systems was applied on poly(propylene) plates using a paint applicator. After drying and weighing, each plate was vertically positioned in a closed container containing 2000 ml water that covered the plate. The containers were placed on a mechanical shaker. At various times 1000 μl water was pipetted out from each system and transferred to 20 ml tubes. After addition of 10 ml ULTIMA GOLD™, the radioactivity, and hence the released amount, was recorded by a liquid scintillation counter (1219 RackBeta, LKB Wallac, Finland). Results are shown in FIG. 3. The release of free medetomidine in water-based paint is about two times faster than that from microspheres. For the solvent-based paint, a similar comparison reveals a ten times faster release from free medetomidine than from microspheres.

### Example 17

### Study of IPBC Release from Painted Surfaces

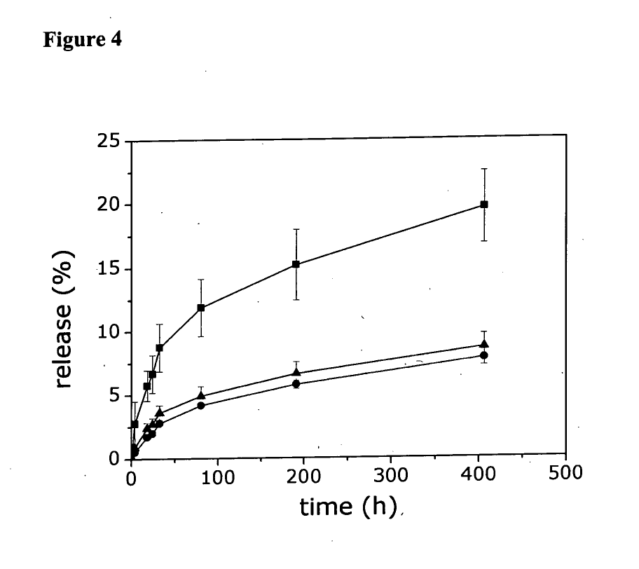

Three different 10 g paint samples were prepared. The samples were based on biocide-free and water-based standard white exterior wall paint. IPBC was added to each sample, either in free form or the form of microspheres with (i) 10% loading and (ii) 25% loading in terms of weight. A specific fraction of the IPBC was ¹⁴C-labelled material. Wet paint contained in total 0.1% IPBC. Stirring the paint assured homogeneous dispersion of the added substance. For the release studies, approximately 0.2 g (dry state) of the paint systems was applied on poly(propylene) plates using a paint applicator. After drying and weighing, each plate was vertically positioned in a closed container containing 250 ml water that covered the plate. The containers were placed on a mechanical shaker. At various times 1000 μl water was pipetted out from each system and transferred to 20 ml tubes. After addition of 4 ml ULTIMA GOLD™, the radioactivity, and hence the released amount, was recorded by a liquid scintillation counter (1219 RackBeta, LKB Wallac, Finland). Results are shown in FIG. 4. The release of free IPBC is about three times faster than that from microspheres.

### Example 18

### Field Test with Medetomidine and Encapsulated Medetomidine in Marine Paint

PMMA test panels 1 dm² was painted by brush with three different biocide free commercially available marine paints. 3 ml of paint were used for each layer and there were two layers applied on each panel. These panels were used as references. To the same paints in different cans were added 0.1% by weight of medetomidine or an equivalent amount of medetomidine encapsulated in microspheres. The paint mixtures were applied to the same kind of test panels as the reference paints. All panels were made in triplicates and mounted randomly on a frame for submersion into the sea on the Swedish west coast (Tjärnö Marine Biological Laboratory). After six months and ten months (June 2009 to December 2009 and in April 2010) of submersion they were inspected. All the reference panels were more or less covered with barnacles and other fouling organisms. On the test panels with paint containing medetomidine or encapsulated medetomidine there were no barnacles or tubeworms attached on the painted side. This proves that even if the medetomidine is encapsulated the release from the paint surface is high enough to prohibit barnacle attachment.

What is claimed is:

1. Slow-releasing microparticles containing an active substance, the microparticles prepared by forming an emulsion from an aqueous phase comprising water and an emulsifier, and a separate organic phase comprising an organic solvent, a polymer for forming microparticle walls, and the active substance.

2. The microparticles of claim 1, wherein the aqueous phase further comprises an organic solvent.

3. The microparticles of claim 2 wherein the organic solvent is ethyl acetate

4. The microparticles of claim 1, wherein the microparticles have an oil core, the organic phase further comprises oil and the active substance is dispersed in the oil core.

5. The microparticles of claim 4, wherein the oil is selected from the group consisting of corn oil, octadecane, dodecane, hexadecane, rape oil, sunflower oil, soybean oil, and palm oil.

6. The microparticles of claim 1, wherein the organic phase further comprises a co-solvent.

7. The microparticles of claim 1, wherein the microparticles have a diameter between 0.2-20 microns.

8. The microparticles of claim 1, wherein the microparticles have a diameter between 0.2-10 microns.

9. The microparticles of claim 1, wherein the active substance is selected from the group consisting of 3-iodo-2-propynyl butylcarbamate (IPBC), butylated hydroxytoluene (BHT), octyl-isothiazolinone (OIT), 4,5-dichloro-2-n-octyl-3-isothiazolinone (DCOIT), tolylfluanide (TF), 4-[1-(2,3-dimethylphenyl)ethyl]-3H-imidazole (medetomidine), 1H-benzimidazol-2-ylcarbamate (carbendazim), 2-pyridinethiol 1-oxidezinc (zinc pyrithione), irgarol, triazines, N,N-diamethylureas, pheromones such as BHT, insecticides, and a combination thereof.

10. The microparticles of claim 9 wherein the active substance is medetomidine

11. The microparticles of claim 1, wherein the polymer for forming microparticle walls is selected from the group consisting of poly(methylmethacrylate) (PMMA), polystyrene, polyvinylpyridine-co-styrene, polyamide, polyester, ethyl cellulose, polyurethane, polyvinylalcohols, polyurea, polylactic acid, and polyvinylpyridine-co-styrene.

12. The microparticles of claim 11, wherein the polymer for forming microparticle walls is poly(methylmethacrylate).

13. The microparticles of claim 1, wherein the microparticles are in a formulation suitable for prolonging the protection of long-life products.

14. The microparticles of claim 13, wherein the formulation is selected from the group consisting of paints, coatings and wood preservatives.

15. The microparticles of claim 14, wherein the paints are selected from the group consisting of water-based paints and solvent-based paints.

16. The microparticles of claim 1, wherein the active substances is a biocide having concentrations up to at least 25% compared to the total weight of the microparticle.

17. The microparticles of claim 1, wherein the active substance is dispersed in a solid microsphere.

18. The microparticles of claim 1, wherein the emulsifier comprises polyvinyl alcohol.

19. A method of preparing microparticles containing an active substance, comprising separately preparing an aqueous phase and an organic phase, wherein the aqueous phase comprises water, and an emulsifier, and the organic phase comprises the organic solvent, a polymer to form microparticle walls, and the active substance.

20. The method of claim 19 wherein the solvent is ethyl acetate

21. The method of claim 20 wherein large amounts of ethyl acetate are used in the emulsion without it resulting in formation of macroscopic plastic granulates.

22. The method of claim 21 wherein the amount of ethyl acetate in the emulsion can be adjusted by modifying the hydrolysis degree of the emulsifier.

23. The method of claim 20, wherein ethyl acetate is used in the aqueous phase as a solvent in the emulsion.

24. The method of claim 19, wherein the method comprises the steps of:
a) slowly adding an organic phase in equal amount to a portion of an aqueous phase, under rigorous stirring;
b) mixing the emulsion with an additional portion of the aqueous phase, evaporating the emulsion to remove the organic solvent and possible co-solvents, resulting in separation of the polymer phase and in formation of a suspension; and
c) collecting the formed microparticles from the suspension.

25. The method of claim 24, wherein the microparticles are collected by centrifuging the suspension.

26. The method of claim 25, wherein the microparticles are collected by sedimentation from the aqueous phase of the suspension.
